(19) United States
(12) Patent Application Publication
(10) Pub. No.: US 2015/0088327 A1
(43) Pub. Date: Mar. 26, 2015

(54) ENERGY SAVINGS FORECASTING METHOD AND DEVICE

(71) Applicant: Azbil Corporation, Tokyo (JP)

(72) Inventors: Atsushi KUROSAKI, Tokyo (JP); Junya NISHIGUCHI, Tokyo (JP); Tomohiro KONDA, Tokyo (JP)

(73) Assignee: Azbil Corporation, Tokyo (JP)

(21) Appl. No.: 14/496,402

(22) Filed: Sep. 25, 2014

(30) Foreign Application Priority Data
Sep. 26, 2013 (JP) 2013-199283

(51) Int. Cl. G05B 13/04; G05F 1/66

(52) U.S. Cl. CPC G05B 13/048; G05F 1/66
USPC 700/291

(57) ABSTRACT

An energy-savings forecasting device includes a provisional savings calculating portion that calculates, based on a simulation model, provisional savings that is obtained when switching from a normal operation to an energy-saving operation, an adjustment factor calculating portion that calculates an adjustment factor by comparing the energy demands calculated by the simulation model and a data model when under normal operation, and a forecasted savings calculating portion that calculates the forecasted savings that is obtained when switching from normal operation to the energy-saving operation, through adjusting the provisional savings by the adjustment factor.

### CROSS REFERENCE TO RELATED APPLICATION

This application claims priority under 35 U.S.C. §119 to Japanese Patent Application No. 2013-199283, filed on Sep. 26, 2013, the entire content of which being hereby incorporated herein by reference.

### FIELD OF TECHNOLOGY

The present invention relates to an energy-savings forecasting technology for forecasting an energy savings amount, saved through an energy-saving operation, executed on the consumer household side.

### BACKGROUND

Amid concerns of a nationwide shortage of electric power in Japan, solutions not only by the energy provider side, but solutions for energy savings on the consumer household side as well are becoming increasingly important. In particular, in addition to solutions or energy savings that have been promoted vigorously thus far, “demand-response” (DR) solutions whereby energy savings are achieved when the supply is under pressure are targeted.

It is necessary for the consumer household side, where energy, whether it be electrical, gas, thermal, or the like, is consumed, to evaluate the effectiveness of the energy-saving operation when executing an energy-saving operation such as in DR in their own equipment, to evaluate whether or not to perform the energy-saving operation. At this time, typically it is an energy-saving operation service provider that proposes the energy-saving operation, and the decision-maker regarding executing the energy-saving operation is a building manager, where this constitutes a contractual relationship between businesses of different industries. Consequently, when there is to be an agreement between a building manager and an energy saving service provider to execute energy-saving operations, it is necessary to be able to convince the building managers side, in particular, through providing forecasted values for the effects of the energy-saving operation. Because of this, there is the need for an energy-savings forecasting technology for forecasting the amounts of energy that will be saved through reductions through the energy-saving operations.

Conventionally, as technologies for forecasting energy demand there have been proposals for technologies wherein forecasting models are constructed for calculating forecasted values for energy demand using one or more results of calculations using a plurality of different forecasting procedures from actual values for energy consumption data and input factor data so as to be able to make forecasts even when there are changes in the factors that have an effect on that which is being forecasted, and then executing each of the forecasting procedures based on the plurality of forecasting procedures, and then selectively outputting one of the various respective forecasted values calculated by the plurality of forecasting procedures using the forecasting model. See, for example, Japanese Unexamined Patent Application Publication No. 2012-194700.

Moreover, as another technology for forecasting energy demand, a technology has been proposed wherein energy demand forecasting is performed based on an energy demand forecasting model that is produced using analytical data and historic data, where the analytical data, which includes human information and/or environmental information for the area that is subject to forecasting, is produced based on image data that is captured by an image sensor. See, for example, Japanese Unexamined Patent Application Publication No. 2011-165152.

Consequently, it is possible to obtain the amount of energy saved through using such an energy demand forecasting technology and forecasting the energy demand before and after executing the energy-saving operations, and then taking the difference therebetween.

In the prior technologies such as this, a data model that has been generated from historic data, acquired in the past, is used to forecast energy demand. However, when forecasting, using this technique, the amount of energy saved through a new energy-saving operation, there is no experience with executing this energy-saving operation in the past, it will not be not possible to provide a forecasted value for the first time that the energy-saving operation is performed. Moreover, the energy-saving operation is an operating state that is executed through a conscious decision of a person. Because of this, there is a problem in that, from a data model that is generated from historical data, obtained in the past, it is not possible to provide a forecasted value for the first time that the energy-saving operation is performed, and thus difficult to obtain an agreement between the building manager and the energy-saving operation service provider, so it ends up that the energy-saving operation is not performed, that is, in principle, it is not possible to perform the energy-saving operation.

Moreover, in order to forecast the amount of energy-saving from a data model, one may consider producing historic data through performing the energy-saving operation provisionally for at least one day, and then obtaining the historic data that is accumulated in the data model. However, in order to perform the energy-saving operation, not only is it necessary to change the set up of the equipment, but also a great deal of work overhead is produced in the normal operations using the equipment. Moreover, in many cases, comparative investigations regarding multiple approaches to energy savings are performed, so this would involve executing each of these individual energy-saving operations separately. As a result, the method wherein historic data is produced through provisionally performing the energy-saving operation is not practical.

The present invention is to solve the problem set forth above, and an aspect thereof is to provide a technology for forecasting, with higher forecasting accuracy, the amount of energy saved, without executing the energy-saving operation in advance, to increase the persuasiveness, for the building manager side, when a building manager and an energy-saving operation service provider are to agree on the first time that an energy-saving operation is to be executed.

### SUMMARY

In order to achieve such an aspect set forth above, the present invention provides an energy-savings forecasting method for using an energy-savings forecasting device for calculating forecasted energy savings that would be obtained from switching an operating state of equipment from a normal operation to an energy-saving operation. The energy-savings forecasting method includes: a simulation calculating step wherein a simulation calculating portion uses a simulation model for deriving energy demand by equipment under a specific operating conditions through simulating equipment operations based on those inputted operating conditions, to calculate a first demand that indicates energy required under normal operation and a second demand that indicates energy required under energy-saving operation; a data model calculating step wherein a data model calculating portion uses a data model for deriving energy demand of the equipment under inputted operating conditions, based on historic data obtained from the operation of the equipment in the past, to calculate a third demand that indicates energy required when operating under normal operation; a provisional savings calculating step wherein a provisional savings calculating device calculates provisional savings, based on the simulation model, through subtracting the second demand from the first demand; an adjustment factor calculating step wherein an adjustment factor calculating portion calculates an adjustment factor for adjusting the first demand to the third demand, by comparing the first demand and the third demand; and a forecasted savings calculating step wherein a forecasted savings calculating portion calculates the forecasted savings for when switching from normal operation to energy-saving operation, through adjusting the provisional savings by the adjustment factor.

In one structural example of the aforementioned energy-savings forecasting method according to the present invention, the adjustment factor is a value wherein the third demand is divided by the first demand.

Moreover, the present invention provides an energy-savings forecasting device for calculating forecasted energy savings that would be obtained from switching an operating state of equipment from a normal operation to an energy-saving operation. The energy-savings forecasting device includes: a simulation calculating portion that uses a simulation model for deriving energy demand by equipment under a specific operating conditions through simulating equipment operations based on those inputted operating conditions, and calculates a first demand that indicates energy required under normal operation and a second demand that indicates energy required under energy-saving operation; a data model calculating portion that uses a data model for deriving energy demand of the equipment under inputted operating conditions, based on historic data obtained from the operation of the equipment in the past, and calculates a third demand that indicates energy required when operating under normal operation; a provisional savings calculating portion that calculates provisional savings, based on the simulation model, through subtracting the second demand from the first demand; an adjustment factor calculating portion that calculates an adjustment factor for adjusting the first demand to the third demand, by comparing the first demand and the third demand; and a forecasted savings calculating portion that calculates the forecasted savings for when switching from normal operation to energy-saving operation, through adjusting the provisional savings by the adjustment factor.

In one structural example of the aforementioned energy-savings forecasting device according to the present invention, the adjustment factor is a value wherein the third demand is divided by the first demand.

Given the present invention, in the consumer household-side equipment that consumes energy such as electricity, glass, thermal energy, or the like, it is possible to obtain forecasted savings that are essentially the same as for the case wherein forecasted from a data model, from provisional savings that are forecasted by a simulation model, even for an energy-saving operation corresponding to a particular day in the data model, without the experience of having been executed in the past.

As a result, providing a technology for forecasting the amount of energy-saving with higher forecasting accuracy when compared to the amount of energy saved that is forecasted from a simulation model alone, and without executing the energy-saving operation in advance, enables greater persuasiveness, for the building manager side, when the building manager and the energy-saving operation service provider are to agree to executing the energy-saving operations for the first time.

### BRIEF DESCRIPTIONS OF THE DRAWINGS

FIG. 1 is a block diagram illustrating a structure for an energy-savings forecasting device.

FIG. 2 is a flowchart illustrating the energy-savings forecasting procedures.

FIG. 3 is a flowchart illustrating the energy-savings forecasting procedures.

FIG. 4 is a graph of the normal operating demand EBS and the energy-saving operation demand ERS.

FIG. 5 is a graph showing the provisional savings EP.

FIG. 6 is a graph showing the normal operating demand EBS and the normal operating demand EBD.

FIG. 7 is a graph illustrating the provisional savings EP and the forecasted savings E.

### DETAILED DESCRIPTION

A form for carrying out the present disclosure will be explained next in reference to the figures.

### Energy Savings Forecasting Device

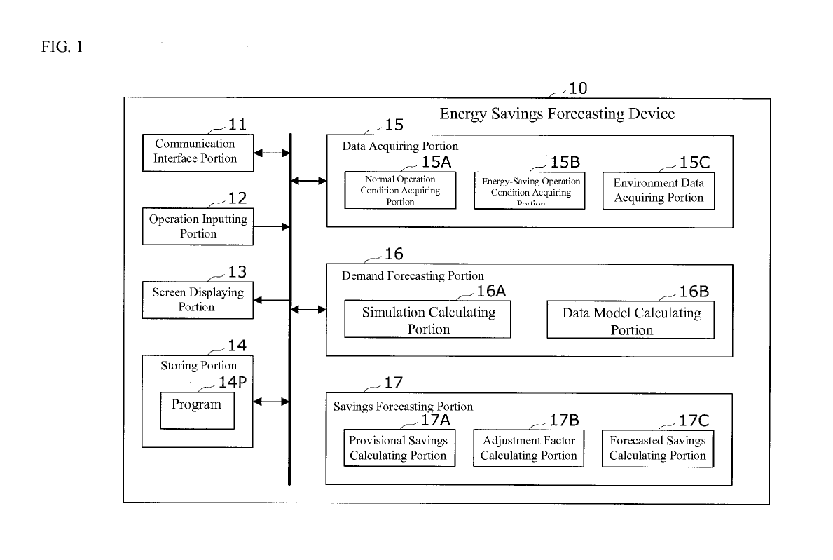

First, an energy-savings forecasting device 10 according to an example according to the present invention will be explained in reference to FIG. 1. FIG. 1 is a block diagram illustrating the structure of an energy-savings forecasting device.

This energy-savings forecasting device 100, as a whole, includes an information processing device such as a server device, a personal computer, or the like, and has a function for calculating the forecasted savings of energy obtained when switching the operating state of the equipment from a normal operation to an energy-saving operation, on the consumer household side that is consuming energy such as electricity, gas, or heat.

The energy-savings forecasting device 10 is provided with a communication interface portion 11, an operation inputting portion 12, a screen displaying portion 13, a storing portion 14, a data acquiring portion 15, a demand forecasting portion 16, and a savings forecasting portion 17, as the primary functional portions thereof.

The communication interface portion 11 has a function for exchanging various types of data, such as the operating conditions and environment data used in forecasting the amount of energy savings, the calculated forecasted energy savings, and the like, through performing data communication with external devices (not shown) that are connected through communication circuits.

The operation inputting portion 12 is made from an operation inputting device such as a keyboard, a mouse, a touch panel, or the like, and has the function of detecting operations by an operator.

The screen displaying portion 13 includes a screen display device, such as an LCD, and has the functions of displaying, on the screen, operating menus and various data such as operating conditions, environment data, forecasted energy savings, and the like.

The storing portion 14 is made from a storage device, such as a hard disk or semiconductor memory, and has the functions of storing various types of data, such as operating conditions used in the procedures for calculating forecasted energy savings, environment data, forecasted energy savings, and the like, and a program 14P.

The program 14P is executed on a CPU (not shown), and is a program for embodying the data acquiring portion 15, the demand forecasting portion 16, and the savings forecasting portion 17, and is stored in advance on to the storing portion 14 from a recording medium or an external device through the communication interface portion 11.

The data acquiring portion 15 has a function for acquiring forecasting condition data such as operating conditions and environment data used in the procedures for calculating the forecasted energy savings, through the communication interface portion 11 or operation inputting portion 12.

This data acquiring portion 15 is provided with a normal operating condition acquiring portion 15A, a power-saving operating condition acquiring portion 15B, and an environment data acquiring portion 15C, as the primary processing portions thereof.

The normal operating condition acquiring portion 15A has a function for acquiring normal operating condition data indicating the operating conditions for normal operation of the equipment.

The power-saving operating condition acquiring portion 15B has a function for acquiring energy-saving operating condition data for energy-saving operation of the equipment.

The environment data acquiring portion 15C has a function for acquiring environment data that indicates the state of the environment that has an effect on the equipment operation.

The normal operating condition data and energy saving operating condition data include equipment operating schedules that indicate changes, for times in schedules, of the starting/stopping or setting values for building equipment that consume energy, such as heat source equipment, air-conditioning equipment, lighting equipment, and the like. Moreover, as environment data there are data that indicate changes over time such as the outside temperature, humidity, ambient pressure, wind direction and wind speed, solar illumination, brightness, cloud cover, and the like, data that indicate changes over time in the interior load such as the occupancy, the IT equipment, and the like, in the building as a whole, on individual floors, or in individual zones, and data indicating whether or not various types of events are occurring. Here, as environment data, forecasted data, such as weather forecasts, and the like, may be used.

The demand forecasting portion 16 has a function for calculating the energy demand required by the equipment when operating under the various operating conditions based on the environment data and the operating conditions obtained by the data acquiring portion 15.

Here a simulation calculating portion 16A and a data model calculating portion 16B are provided as the primary processing portions in the demand forecasting portion 16.

The simulation calculating portion 16A has a function for calculating demand that indicates the energy that will be required when operating the equipment under specific operating conditions using a simulation model that calculates the energy demand by the equipment under those operating conditions, through simulating the operations of the equipment under inputted operating conditions.

More specifically, the simulation calculating portion 16A has a function for calculating a normal-operation demand EBS (a first demand) for indicating the energy required when the equipment is operating under normal operations, through the use of a simulation model based on the environment data obtained by the environment data acquiring portion 15C and the normal operating conditions obtained by the normal operation condition acquiring portion 15A, and a function for calculating an energy-saving-operation demand ERS (a second demand) for indicating the energy required when the equipment is operating under energy-saving operations, through the use of a simulation model based on the environment data obtained by the environment data acquiring portion 15C and the energy-saving operating conditions obtained by the energy-saving operation condition acquiring portion 15B.

The data model calculating portion 16B has a function for calculating the demand that indicates the energy required when operating the equipment under the specific operating conditions, using a data model for deriving the energy demand under the inputted operating conditions, based on historical data obtained from operating the equipment in the past.

More specifically, the data model calculating portion 16B has a function for calculating a normal operation demand EBD (a third demand) that indicates the energy required when operating the equipment in normal operation, through the use of a data model, based on the environment data acquired by the environment data acquiring portion 16C and the normal operating conditions acquired by the normal operation condition acquiring portion 15A.

As a specific example, the simulation model may use a well-known energy simulator, such as EnergyPlus (http://appsl.eere.energy.gov/buildings/energyplus/), published by the United States Department of Energy. While here incorporating the simulation results quantitatively would require a large amount of effort in the reconciliation, here all that is needed is only a qualitative expression through simple settings.

As a specific example of a data model, well-known empirical inference models such as, for example, the TCBM (Topological Case-Based Modeling: http://www.azbil.com/jp/product/ias/sp/sp_forest.html) may be used.

The savings forecasting portion 17 has a function for calculating the forecasted energy savings, obtained when switching the operation of the equipment from normal operation to energy-saving operation, based on the normal operation demand EBS, the energy-saving operation demand ERS, and the normal operation demand EBD, calculated by the demand forecasting portion 16.

This savings forecasting portion 17 has a provisional savings calculating portion 17A, an adjustment factor calculating portion 17B, and a forecasted savings calculating portion 17C, as the primary processing portions thereof.

The provisional savings calculating portion 17A has a function for calculating provisional savings EP based on a simulation model, through subtracting the energy-saving operation demand ERS, calculated by the simulation calculating portion 16A, from the normal operation demand EBS, calculated by the simulation calculating portion 16A.

The adjustment factor calculating portion 17B has a function for calculating an adjustment factor a, for adjusting the normal operation demand EBS to the normal operation demand EBD, through comparing the normal operation demand EBS, calculated by the simulation calculating portion 16A, and the normal operation demand EBD, calculated by the data model calculating portion 16B.

As a specific example of an adjustment factor, one may consider a ratio of the normal operation demand EBS and the normal operation demand EBD. This is because there is a high correlation between the normal operation demand EBS and the normal operation demand EBD. The method for calculating this ratio may use, for example, a technique wherein a ratio is taken between the maximum value for the normal operation demand EBS and a maximum value for the normal operation demand EBD over one day's worth of operating under normal operation, but instead of the maximum value, the ratio may be that of measures of central tendency of the normal operation demand EBS and normal operation demand EBD, calculated by a statistical technique such as a mean, a median, or the like, instead of the maximum value. Moreover, ratios of the measures of central tendency may be taken respectively in different time bands, such as morning, afternoon, and evening.

The forecasted savings calculating portion 17C has a function for calculating the forecasted energy savings E obtained through switching the operation of the equipment from normal operation to energy-saving operation, through adjusting the provisional savings EP, calculated by the provisional savings calculating portion 17A, through the adjustment factor a that was calculated by the adjustment factor calculating portion 17B.

### Operation of the Present Example

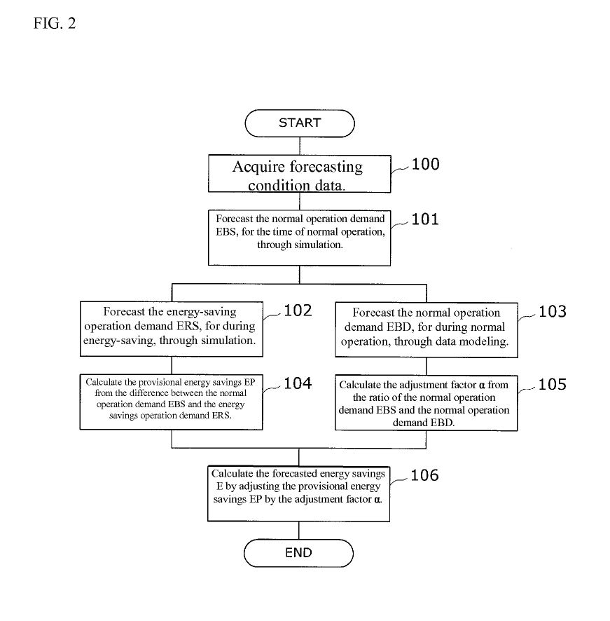

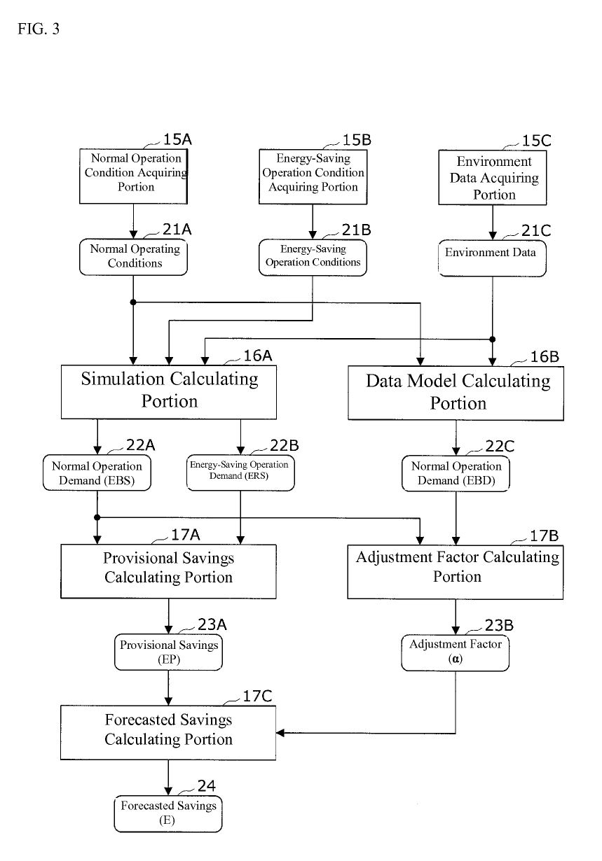

The operation of the energy-savings forecasting device 10 according to the present example will be explained next in reference to FIG. 2 and FIG. 3. FIG. 2 is a flowchart illustrating an energy-savings forecasting procedure. FIG. 3 is a flowchart illustrating the energy-savings forecasting procedures.

First the data acquiring portion 15 acquires forecasting condition data such as the operating condition, environment data, and the like, used in the process of calculating the forecasted energy savings, through the communication interface portion 11 and/or the operation inputting portion 12 (Step 100). Through this, the normal operation conditions 21A, energy-saving operation conditions 21B, and environment data 21C are acquired by the normal operation condition acquiring portion 15A, the energy-saving operation condition acquiring portion 15B, and the environment data acquiring portion 15C, and stored in the storing portion 14.

Following this, the demand forecasting portion 16 calculates the energy demand required by the equipment for the case of operating under normal operation conditions and under energy-saving operation conditions, based on the normal operation conditions 21A, the energy-saving operation conditions 21B, and the environment data 21C, from the storing portion 14 (Step 101-103).

Specifically, first the normal operation demand EBS (22A) that indicates the energy required when operating the equipment in normal operation is calculated through the use of the simulation model, based on the normal operation conditions 21A and the environment data 21C (Step 101).

Thereafter, the simulation calculating portion 16A uses the simulation model to calculate the energy-saving operation demand ERS (22B), which indicates the energy that would be required to operate the equipment in energy-saving operations, based on the energy-saving operation conditions 21B and the environment data 21C (Step 102).

On the other hand, the data model calculating portion 16B uses the data model to calculate the normal operation demand EBD (22C), which indicates the energy that would be required to operate the equipment in normal operations, based on the normal operating conditions 21A and the environment data 21C (Step 103).

Following this, the savings forecasting portion 17 calculates the forecasted energy savings E (24) that would be obtained by switching the operating state of the equipment from normal operation to energy-saving operation, based on the normal operation demand EBS (22A), the energy-saving operation demand ERS (22B), and the normal operation demand EBD (22C), calculated by the demand forecasting portion 16 (Step 104-106).

Specifically, first the provisional savings calculating portion 17A calculates the provisional savings EP (23A) based on the simulation model, by subtracting the energy-saving operation demand ERS (22B) from the normal operation demand EBS (22A) (Step 104).

On the other hand, the adjustment factor calculating portion 17B calculates the adjustment factor a (23B), for adjusting the normal operation demand EBS (22A) to the normal operation demand EBD (22C), through comparing the normal operation demand EBS (22A) and the normal operation demand EBD (22C) (Step 105).

Thereafter, the forecasted savings calculating portion 17C multiplies the provisional savings EP (23A) by the adjustment factor α (23B), to adjust the provisional savings EP (23 A) to calculate the forecasted energy savings E (24) that would be obtained when switching the operating state of the equipment from normal operation to energy-saving operation (Step 106).

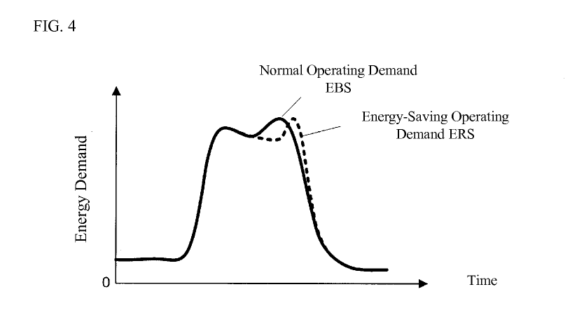

FIG. 4 is a graph of the normal operating demand EBS and the energy-saving operation demand ERS. Here a time graph of the normal operation demand EBS over one day wherein normal operation was executed is shown by the solid line graph, and a time graph of the energy-saving operation demand ERS over one day over which energy-saving operation was executed is shown by the dotted line graph.

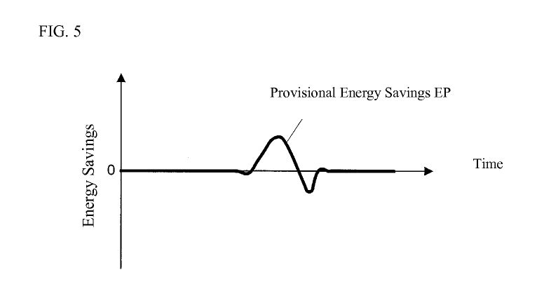

FIG. 5 is a graph showing the provisional savings EP. Here a time graph of the provisional savings EP is illustrated by the solid line graph, and can be understood to correspond to the difference between the normal operation demand EBS and the energy-saving operation demand ERS in FIG. 4.

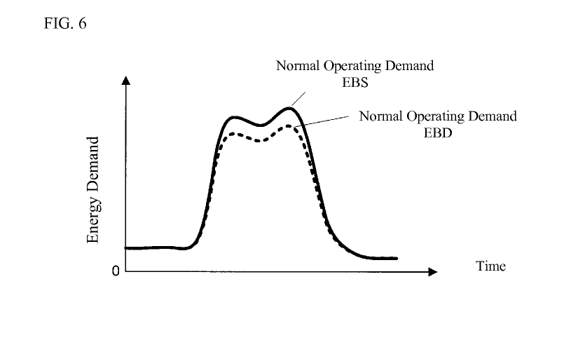

FIG. 6 is a graph showing the normal operating demand EBS and the normal operating demand EBD. Here the time graph of the normal operation demand EBS, forecasted from the simulation model, for one day over which the normal operation is implemented is illustrated by the solid line graph, and the time graph of the normal operation demand EBD that was forecasted by the data model is shown by the dotted line graph.

As can be understood from FIG. 6, there is a strong correlation between the normal operation demand EBS and the normal operation demand EBD, and by calculating a ratio between the two it is possible to adjust (correct) the amount of energy savings forecasted by the simulation model, that is, the provisional savings EP, to an amount of energy savings forecasted by the data model, that is, the desired forecasted savings E.

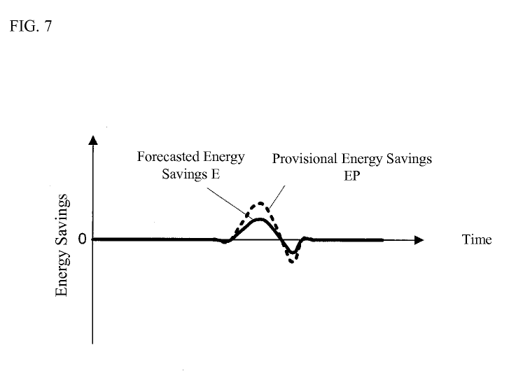

FIG. 7 is a graph illustrating the provisional savings EP and the forecasted savings E. Here the provisional savings EP forecasted from the simulation model are shown by the dotted line graph, and the forecasted savings E, obtained through adjusting this using the adjustment factor a, are shown by the solid line graph. This makes it possible to perform highly accurate forecasts, essentially the same as those forecasted using a data model, for the forecasted savings E for the energy savings in the energy-saving operation, which is an operating state for which there is no historic data for a data model.

In this way, in the present example, the provisional savings calculating portion 17A calculates, based on the simulation model, the provisional savings EP obtained when switching from normal operation to energy-saving operation, the adjustment factor calculating portions 17B calculates an adjustment factor a by comparing the energy demands calculated by the simulation model and by the data model when operating under normal operation, and the forecasted savings calculating portion 17C calculates a forecasted savings E that would be obtained through switching from normal operation to energy-saving operation, through adjusting the provisional savings EP by the adjustment factor α.

As a result, it is possible to obtain forecasted savings E that are essentially the same as those when forecasting with a data model, from the provisional savings EP that are forecasted by a simulation model, even when under energy-saving operation that corresponds to a particular day in the data model, even without having had past experience in doing so on the equipment, on the consumer household side, that consumes the energy such as electricity, gas, thermal energy, or the like.

As a result, providing a technology for forecasting the amount of energy-saving with higher forecasting accuracy when compared to the amount of energy saved that is forecasted from a simulation model alone, and without executing the energy-saving operation in advance, enables greater persuasiveness, for the building manager side, when the building manager and the energy-saving operation service provider are to agree to executing the energy-saving operations for the first time.

### Extended Examples

While the present disclosure was explained above in reference to examples, the present disclosure is not limited by the examples set forth above. The structures and details of the present disclosure may be modified in a variety of ways, as can be understood by those skilled in the art, within the scope of the present disclosure.

1. An energy-savings forecasting method for using an energy-savings forecasting device for calculating forecasted energy savings that would be obtained from switching an operating state of equipment from a normal operation to an energy-saving operation, the method comprising:
a simulation calculating step wherein a simulation calculating portion uses a simulation model for deriving energy demand by equipment under a specific operating conditions through simulating equipment operations based on those inputted operating conditions, to calculate a first demand that indicates energy required under normal operation and a second demand that indicates energy required under energy-saving operation;
a data model calculating step wherein a data model calculating portion uses a data model for deriving energy demand of the equipment under inputted operating conditions, based on historic data obtained from the operation of the equipment in the past, to calculate a third demand that indicates energy required when operating under normal operation;
a provisional savings calculating step wherein a provisional savings calculating device calculates provisional savings, based on the simulation model, through subtracting the second demand from the first demand;
an adjustment factor calculating step wherein an adjustment factor calculating portion calculates an adjustment factor for adjusting the first demand to the third demand, by comparing the first demand and the third demand; and
a forecasted savings calculating step wherein a forecasted savings calculating portion calculates the forecasted savings for when switching from normal operation to energy-saving operation, through adjusting the provisional savings by the adjustment factor.

2. The energy-savings forecasting method as set forth in claim 1, wherein:
the adjustment factor is a value wherein the third demand is divided by the first demand.

3. An energy-savings forecasting device for calculating forecasted energy savings that would be obtained from switching an operating state of equipment from a normal operation to an energy-saving operation, the energy-savings forecasting device comprising:
a simulation calculating portion that uses a simulation model for deriving energy demand by equipment under a specific operating conditions through simulating equipment operations based on those inputted operating conditions, and calculates a first demand that indicates energy required under normal operation and a second demand that indicates energy required under energy-saving operation;
a data model calculating portion that uses a data model for deriving energy demand of the equipment under inputted operating conditions, based on historic data obtained from the operation of the equipment in the past, and calculates a third demand that indicates energy required when operating under normal operation;
a provisional savings calculating portion that calculates provisional savings, based on the simulation model, through subtracting the second demand from the first demand;
an adjustment factor calculating portion that calculates an adjustment factor for adjusting the first demand to the third demand, by comparing the first demand and the third demand; and
a forecasted savings calculating portion that calculates the forecasted savings for when switching from normal operation to energy-saving operation, through adjusting the provisional savings by the adjustment factor.

4. The energy-savings forecasting device as set forth in claim 3, wherein:
the adjustment factor is a value wherein the third demand is divided by the first demand.
